(19) United States
(12) Patent Application Publication
(10) Pub. No.: US 2025/0210949 A1
(43) Pub. Date: Jun. 26, 2025

(54) PROTECTOR AND WIRE HARNESS

(71) Applicant: Yazaki Corporation, Tokyo (JP)

(72) Inventor: Hiroyuki Nishi, Tochigi (JP)

(21) Appl. No.: 18/964,022

(22) Filed: Nov. 29, 2024

(30) Foreign Application Priority Data
Dec. 25, 2023 (JP) 2023-218106

(51) Int. Cl. H02G 3/04; B60R 16/02; H01B 7/00

(52) U.S. Cl. CPC H02G 3/0418; B60R 16/0215; H01B 7/0045

(57) ABSTRACT

A protector attached to an electric wire bundle to protect the electric wire bundle, the protector includes a main body in which side walls are erected on both side edges of a bottom wall and a housing portion for housing the electric wire bundle is formed, a cover pivotally connected to an edge of any one of the side walls constituting the main body and configured to be disposed in an open state in which the housing portion is opened or a closed state in which the housing portion is closed, and a hinge configured to pivotally connect the cover to the side walls. The cover is pivotally connected to the main body by the hinge about a pivot axis inclined with respect to an extending direction of the main body in a plan view.

### CROSS-REFERENCE TO RELATED APPLICATIONS

This application is based on and claims priority under 35 USC 119 from Japanese Patent Application No. 2023-218106 filed on Dec. 25, 2023, the entire content of which is incorporated herein by reference.

### TECHNICAL FIELD

The present disclosure relates to a protector and a wire harness.

### BACKGROUND ART

For example, a wire harness routed in a vehicle such as an automobile has a protector that covers and protects an electric wire bundle, and is routed by fixing the protector to a fixed position such as a body or a door of the vehicle.

As shown in FIG. 5, there is a protector including a U-shaped main body 2 having a housing portion for housing an electric wire bundle 1, and a cover 5 integrally connected to an upper edge of one side wall 3 constituting the main body 2 by a hinge 4 (for example, see JP2016-119740A, JP2012-170263A, and JP2004-357415A). In the protector, in a state in which the electric wire bundle 1 is housed in the main body 2, the cover 5 is pivoted by the hinge 4 to block an upper portion of the main body 2, and an edge of the cover 5 is engaged and locked with the main body 2 by the side wall 3 opposite to the hinge 4.

In the protector having the above-described structure, the hinge 4 that pivotally connects the cover 5 to the main body 2 has a pivot axis parallel to an extending direction of the main body 2. Accordingly, the cover 5 is naturally pivoted by the hinge 4 to open and close an upper portion of the housing portion of the main body 2.

Incidentally, as a routing path of the wire harness becomes complicated, a bent portion may be provided in the middle of the protector. In such a case, since the main body 2 also has a bent shape, when the pivot axis of the hinge 4 is made parallel to the main body 2, a portion of the cover 5 overlaps the main body 2 in a plan view in a state in which the cover 5 is opened, making molding using a mold difficult. Therefore, in this case, the cover 5 is formed separately from the main body 2, the electric wire bundle 1 is housed in the housing portion of the main body 2, and the separate cover 5 is attached to the main body 2. Hence, cost of the protector increases, and an operation of attaching the protector to the electric wire bundle 1 also becomes complicated.

The present disclosure has been made in view of the above circumstances, and an object thereof is to provide a protector that can be easily attached to an electric wire bundle at a reduced cost even if the protector has a complicated routing path, and a wire harness including the same.

### SUMMARY OF INVENTION

The following configuration achieves the above object of the present disclosure.

The embodiment of the present disclosure provides a protector attached to an electric wire bundle to protect the electric wire bundle, the protector including:
a main body in which side walls are erected on both side edges of a bottom wall and a housing portion for housing the electric wire bundle is formed;
a cover pivotally connected to an edge of any one of the side walls constituting the main body and configured to be disposed in an open state in which the housing portion is opened or a closed state in which the housing portion is closed; and
a hinge configured to pivotally connect the cover to the side walls, in which
the cover is pivotally connected to the main body by the hinge about a pivot axis inclined with respect to an extending direction of the main body in a plan view.

The present disclosure provides a wire harness including
the protector according to the above embodiment; and
an electric wire bundle to which the protector is attached.

The present disclosure provides a protector which can be easily attached to an electric wire bundle at a reduced cost even if the protector has a complicated routing path, and a wire harness including the same.

The present disclosure has been briefly described above. Further, the details of the present disclosure can be clarified by reading modes (hereinafter, referred to as “embodiments”) for carrying out the disclosure to be described below with reference to the accompanying drawings.

### BRIEF DESCRIPTION OF DRAWINGS

FIG. 1 is a plan view of a protector according to the present embodiment with a cover in an open state;

FIG. 2 is a plan view of the protector according to the present embodiment with the cover in a closed state;

FIG. 3 is a plan view of a part of a protector according to a reference example;

FIG. 4 is a plan view of a part of a protector according to a reference example; and

FIG. 5 is a perspective view showing an example of a protector having a structure in the related art.

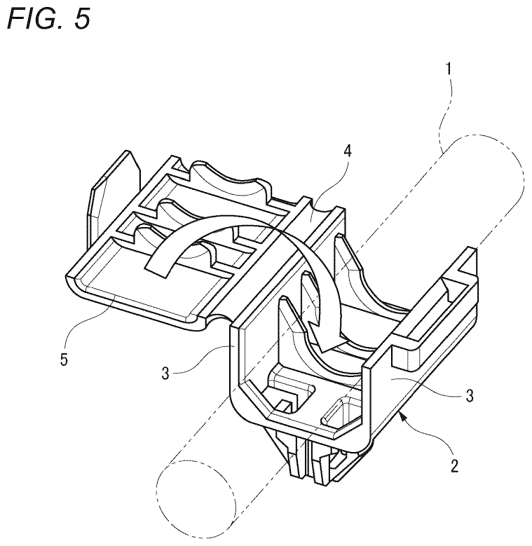

### DESCRIPTION OF EMBODIMENTS

Specific embodiments of the present disclosure will be described below with reference to the drawings.

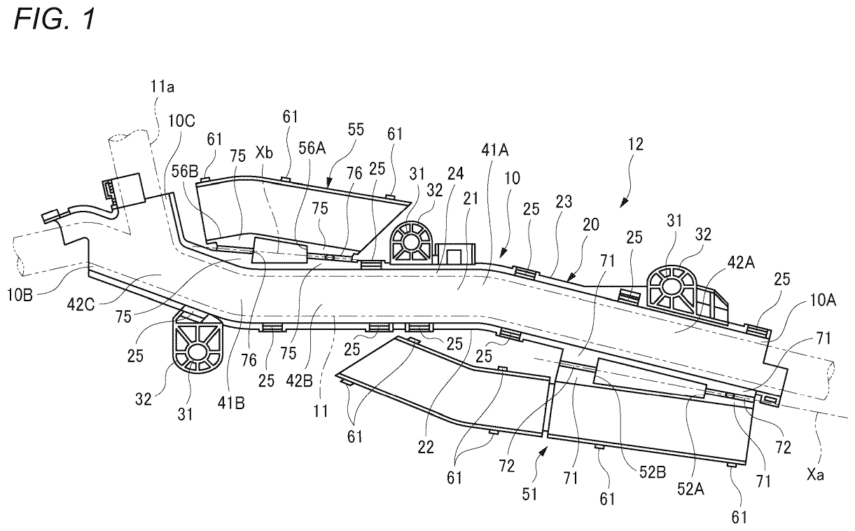

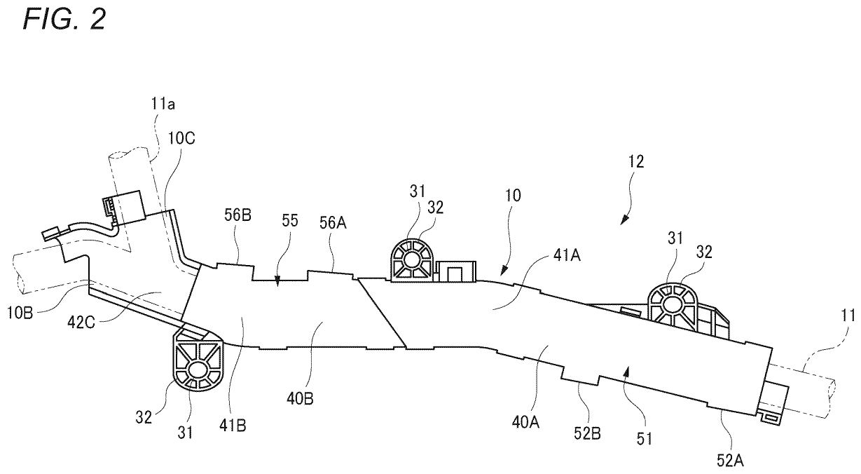

FIG. 1 is a plan view of a protector 10 according to the present embodiment with covers 51 and 55 in an open state. FIG. 2 is a plan view of the protector 10 according to the present embodiment with the covers 51 and 55 in a closed state.

As shown in FIGS. 1 and 2, the protector 10 according to the present embodiment is assembled to an electric wire bundle 11 formed by bundling a plurality of electric wires to form a wire harness 12. In the wire harness 12, the periphery of the electric wire bundle 11 is covered and protected by the protector 10.

The wire harness 12 including the protector 10 is routed in a vehicle such as an automobile, and the protector 10 is fixed to an attached portion such as a body of the vehicle.

The protector 10 is formed in an elongated shape. The protector 10 has an electric wire lead-out portion 10A at one end and an electric wire lead-out portion 10B at the other end. The protector 10 has a branch wire lead-out portion 10C near the other end. In the protector 10, the electric wire bundle 11 is drawn out from the electric wire lead-out portions 10A and 10B, and a branch wire 11a branched from the electric wire bundle 11 is drawn out from the branch wire lead-out portion 10C.

The protector 10 includes a main body 20 and two covers 51 and 55. The main body 20 and the covers 51 and 55 are made of insulating synthetic resin, and are integrally molded by injection molding or the like.

The main body 20 includes a bottom wall 21 and side walls 22 and 23 erected on both edges of the bottom wall 21, and is formed in a substantially U-shape in a cross-sectional view with an open upper portion. In the main body 20, a portion surrounded by the bottom wall 21 and the side walls 22 and 23 is a housing portion 24 for housing the electric wire bundle 11. A plurality of locking portions 25 are provided on upper edges of the side walls 22 and 23 constituting the main body 20.

The cover 51 is integrally connected to the main body 20 by two hinges 52A and 52B. The hinges 52A and 52B are formed at the upper edge of one side wall 22 of the main body 20, and the cover 51 is pivotally connected to the main body 20 by the hinges 52A and 52B.

The cover 55 is integrally connected to the main body 20 by two hinges 56A and 56B. The hinges 56A and 56B are formed at the upper edge of the other side wall 23 of the main body 20, and the cover 55 is pivotally connected to the main body 20 by the hinges 56A and 56B.

As described above, the cover 51 is pivotally connected to the main body 20 by the hinges 52A and 52B about a pivot axis Xa, and the cover 55 is pivotally connected to the main body 20 by the hinges 56A and 56B about a pivot axis Xb. When the covers 51 and 55 are pivoted at the hinges 52A, 52B, 56A, and 56B, the covers 51 and 55 are brought into an open state (the state shown in FIG. 1) in which the housing portion 24 of the main body 20 is opened and a closed state (the state shown in FIG. 2) in which the housing portion 24 of the main body 20 is closed. By pivoting the covers 51 and 55 toward the main body 20 to be in the closed state, an opened upper portion of the housing portion 24 of the main body 20 is blocked by the covers 51 and 55, and the electric wire bundle 11 housed in the housing portion 24 is prevented from slipping out.

The covers 51 and 55 have a plurality of locking claws 61. The cover 51 has the locking claws 61 on both edges, and the cover 55 has the locking claws 61 on edges opposite to the hinges 56A and 56B. When the covers 51 and 55 are in the closed state in which the housing portion 24 of the main body 20 is closed, the locking claws 61 are locked to the locking portions 25 of the main body 20. Accordingly, the covers 51 and 55 are maintained in the closed state in which the housing portion 24 of the main body 20 is closed.

In the protector 10, a plurality of attachment portions 32 having attachment holes 31 are formed in the main body 20. The main body 20 is fixed to the body or the like of the vehicle by fastening a fixing member (not shown) such as a bolt or a grommet inserted into the attachment holes 31 of the attachment portions 32 to the attached portion such as the body of the vehicle. In the open state, the covers 51 and 55 are provided at positions that do not overlap any of the attachment portions 32 in the plan view.

In the protector 10 having the above structure, the main body 20 has bent portions 41A and 41B at a plurality of positions (two positions in this example) in a longitudinal direction, and a routing path is bent in an opposite direction at the bent portions 41A and 41B. Accordingly, the main body 20 of the protector 10 has a plurality of (three in this example) linear portions 42A, 42B, and 42C in the longitudinal direction.

The cover 51 is attached in a range over the linear portions 42A and 42B including the bent portion 41A, and the cover 55 is attached in a range over the linear portions 42B and 42C including the bent portion 41B. Therefore, in the open state in which the covers 51 and 55 are pivoted to a side opposite to the main body 20 to open the housing portion 24, the covers 51 and 55 are bent in a direction opposite to the main body 20 in the plan view (see FIG. 1).

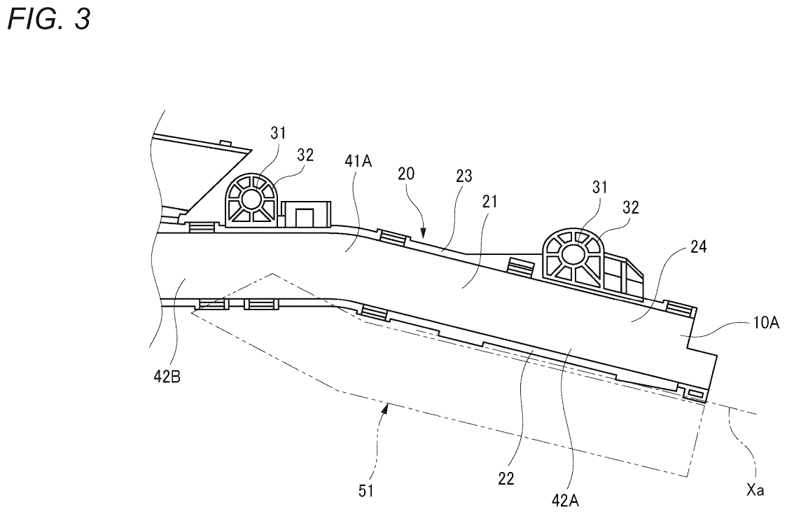

Incidentally, as shown in FIG. 3, in the cover 51 attached in the range over the linear portions 42A and 42B including the bent portion 41A, for example, the pivot axis Xa of the hinges 52A and 52B is parallel to an extending direction of one linear portion 42A on which the hinges 52A and 52B are formed. Then, when the cover 51 is opened, a portion of the cover 51 overlaps the main body 20 in the plan view, which makes it difficult to perform integral molding using a mold.

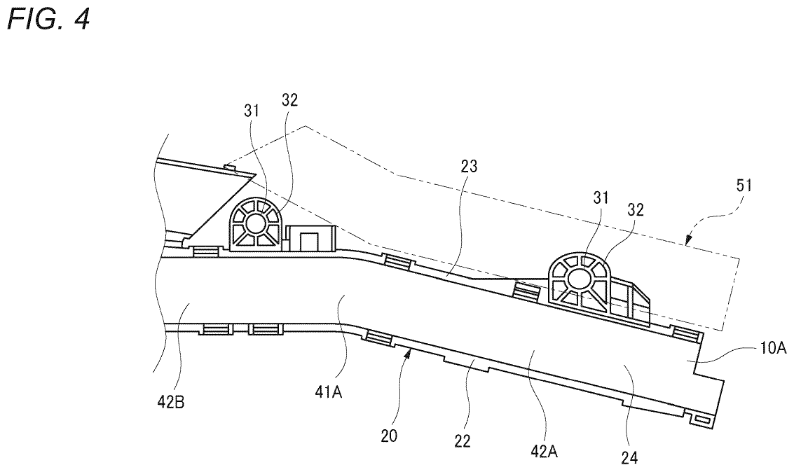

Here, as shown in FIG. 4, it is conceivable to connect the cover 51 to the other side wall 22 of the main body 20 such that a bent side faces outward, but in this case, the attachment portion 32 and the cover 51 overlap in the plan view, which also makes it difficult to perform integral molding using a mold.

In the protector 10 according to the present embodiment, as shown in FIG. 1, each of the hinges 52A and 52B includes a pair of support plates 71 extending in a direction orthogonal to the side wall 22 of the main body 20 in the open state of the cover 51, and a pivot portion 72 provided between the support plates 71, and is pivotal by the pivot portion 72. In the hinges 52A and 52B, the pivot axis Xa at the pivot portion 72 is inclined with respect to an extending direction of the linear portion 42A of the main body 20 to which the hinges 52A and 52B are connected by adjusting an extending length of the support plate 71 and a position of the pivot portion 72. Accordingly, the cover 51 in the open state is disposed to be inclined with respect to the extending direction of the linear portion 42A of the main body 20 without overlapping the main body 20 in the plan view, and the main body 20 and the cover 51 can be integrally molded by a mold. The cover 51 is pivoted toward the main body 20 about the pivot axis Xa, so that the cover 51 is disposed at a position where the cover 51 blocks the housing portion 24, and is naturally brought into a closed state.

Similarly, each of the hinges 56A and 56B includes a pair of support plates 75 extending in a direction orthogonal to the side wall 23 of the main body 20 in the open state of the cover 55, and a pivot portion 76 provided between the support plates 75, and is pivotal by the pivot portion 76. In the hinges 56A and 56B, the pivot axis Xb at the pivot portion 76 is inclined with respect to an extending direction of the linear portions 42B and 42C of the main body 20 to which the hinges 56A and 56B are connected by adjusting an extending length of the support plate 75 and a position of the pivot portion 76. Accordingly, the cover 55 in the open state is disposed to be inclined with respect to the extending direction of the linear portions 42B and 42C of the main body 20 without overlapping the main body 20 in the plan view, and the main body 20 and the cover 55 can be integrally molded by a mold. The cover 55 is pivoted toward the main body 20 about the pivot axis Xb, so that the cover 55 is disposed at a position where the cover 55 blocks the housing portion 24, and is naturally brought into a closed state.

As described above, according to the protector 10 of the present embodiment, even in the case where the protector 10 has a complicated routing path in which the main body 20 is bent, the covers 51 and 55 in the open state can be disposed to be inclined with respect to the extending direction of the main body 20 in the plan view, thereby eliminating overlap with the main body 20. Accordingly, the protector 10 in which the covers 51 and 55 are integrally connected to the main body 20 can be molded using a mold without separating the main body 20 and the covers 51 and 55. Therefore, according to the protector 10, the cost is reduced, and the protector 10 can be easily attached to the electric wire bundle 1.

According to the present embodiment, by adjusting the extending lengths of the support plates 71 and 75 and the positions of the pivot portions 72 and 76 of the hinges 52A, 52B, 56A, and 56B, the pivot axes Xa and Xb of the covers 51 and 55 can be easily inclined with respect to the extending direction of the main body 20 in the plan view.

In addition, in the open state of the covers 51 and 55, the overlap between the covers 51 and 55 and the attachment portion 32 in the plan view can be eliminated. Accordingly, the protector 10 in which the covers 51 and 55 are integrally connected to the main body 20 having the attachment portion 32 can be molded using a mold without separating the main body 20 and the covers 51 and 55.

According to the wire harness 12 including the protector 10, the protector 10 can be attached to the electric wire bundle 1 and then attached to the body of the vehicle, so that routing can be easily performed.

The present disclosure is not limited to the embodiments described above and can be appropriately modified, improved and the like. Materials, shapes, sizes, numbers, arrangement positions, and the like of components in the embodiments described above are freely selected and are not limited as long as the present disclosure can be implemented.

Here, features of the embodiments of the protector and the wire harness according to the present disclosure described above are briefly summarized and listed in the following [1] to [4]. [1] A protector (10) attached to an electric wire bundle (11) to protect the electric wire bundle (11), the protector including:
a main body (20) in which side walls (22, 23) are erected on both side edges of a bottom wall (21) and a housing portion (24) for housing the electric wire bundle (11) is formed;
a cover (51, 55) pivotally connected to an edge of any one of the side walls (22, 23) constituting the main body (20) and configured to be disposed in an open state in which the housing portion (24) is opened or a closed state in which the housing portion (24) is closed; and
a hinge (52A, 53B, 56A, 56B) configured to pivotally connect the cover (51, 55) to the side walls (22, 23), in which
the cover (51, 55) is pivotally connected to the main body (20) by the hinge (52A, 53B, 56A, 56B) about a pivot axis (Xa, Xb) inclined with respect to an extending direction of the main body (20) in a plan view.

According to the protector having the configuration of [1], the cover is pivotally connected to the main body about the pivot axis inclined with respect to the extending direction of the main body in the plan view. Accordingly, even in the case where the protector has a complicated routing path in which the main body is bent, the cover in the open state can be disposed to be inclined with respect to the extending direction of the main body in the plan view, thereby eliminating overlap with the main body. Accordingly, the protector in which the cover is integrally connected to the main body can be molded using a mold without separating the main body and the cover. Therefore, the cost is reduced, and the protector can be easily attached to the electric wire bundle.

[2] The protector according to [1], in which
the hinge (52A, 53B, 56A, 56B) includes a pair of support plates (71, 75) extending in a direction orthogonal to the side walls (22, 23) of the main body (20) in the open state of the cover (51, 55), and a pivot portion (72, 76) provided between the support plates (71, 75).

According to the protector having the configuration of [2], by adjusting an extending length of the support plate of the hinge and a position of the pivot portion, the pivot axis of the cover can be easily inclined with respect to the extending direction of the main body in the plan view.

[3] The protector according to [1], in which
the main body (20) includes an attachment portion 32 to be attached to an attached portion of a vehicle on a side opposite to a side where the cover (51, 55) is connected by the hinge (52A, 53B, 56A, 56B).

According to the protector having the configuration of [3], in the open state of the cover, the overlap between the cover and the attachment portion in the plan view can be eliminated. Accordingly, the protector in which the cover is integrally connected to the main body having the attachment portion can be molded using a mold without separating the main body and the cover. [4] A wire harness including:
the protector 10 according to any one of [1] to [3]; and
an electric wire bundle 11 to which the protector 10 is attached.

According to the wire harness having the configuration of [4], the protector can be attached to the electric wire bundle and then attached to the body or the like of the vehicle, so that routing can be easily performed.

What is claimed is:

1. A protector attached to an electric wire bundle to protect the electric wire bundle, the protector comprising:
a main body in which side walls are erected on both side edges of a bottom wall and a housing portion for housing the electric wire bundle is formed;
a cover pivotally connected to an edge of any one of the side walls constituting the main body and configured to be disposed in an open state in which the housing portion is opened or a closed state in which the housing portion is closed; and
a hinge configured to pivotally connect the cover to the side walls, wherein
the cover is pivotally connected to the main body by the hinge about a pivot axis inclined with respect to an extending direction of the main body in a plan view.

2. The protector according to claim 1, wherein
the hinge includes a pair of support plates extending in a direction orthogonal to the side walls of the main body in the open state of the cover, and a pivot portion provided between the support plates.

3. The protector according to claim 1, wherein
the main body includes an attachment portion to be attached to an attached portion of a vehicle on a side opposite to a side where the cover is connected by the hinge.

4. A wire harness comprising:
the protector according to claim 1; and
an electric wire bundle to which the protector is attached.
